(19) United States
(12) Patent Application Publication
(10) Pub. No.: US 2007/0128237 A1
(43) Pub. Date: Jun. 7, 2007

(54) Soil additive composition having visual perceptibility

(76) Inventor: Michael Haile, Dixon, CA (US)

Correspondence Address: THEODORE J. BIELEN JR., 1390 WILLOW PASS ROAD, SUITE 1020, CONCORD, CA, 94520, US

(21) Appl. No.: 11/296,070

(22) Filed: Dec. 6, 2005

(51) Int. Cl. A01N 25/00

(52) U.S. Cl. 424/405

(57) ABSTRACT

A soil additive composition employing a spreadable component applicable to the surface of the soil the spreadable component is combined with a plurality of particles reflective of electromagnetic radiation such as light. The spreadable component and plurality of particles may be pumpable in order to deliver these elements to a ground surface.

### BACKGROUND OF THE INVENTION

The present invention relates to a novel and useful soil additive composition which provides a visual or indication of the presence of the composition.

Various components are intentionally spread on soil surfaces to prevent soil erosion, to provide a dust palliative, manage storm water to fertilize, and to provide biocidal treatment. Among these components numerous polymers have been employed as primary ingredients, adjuvants, additives and as direct soil amendments. These materials are generally applied by spreading them over the soil surface using various methods and pieces of equipment, including but not limited to, spreaders, broadcasters, sprayers, hose end proptioners, hydroseeders, water trucks, ultra low volume applicators, aircraft, and also through irrigation systems. In the past, such spreadable materials, although applied to the surface of soils, were not visible or discernable following such application. Consequently, accurate records must be kept as to where and when such spreadable materials have been deposited or used. Unfortunately, records are not always accurate, resulting in the omitance of the application of such materials, or the duplication of efforts in this regard.

In addition various materials such as petroleum products and chemicals, including fuel, minerals and other materials have been intentionally, inadvertently or accidentally deposited or spilled on a soil surface, contaminating the soil and potentially, or directly, causing pollution of the soil, the subsurface ground water, riparian areas such as wetlands and surface waters such as rivers and lakes. These pollutants are known to regulatory authorities as “invisible pollutants”.

In the past, luminescent particles have been devised. For example, U.S. Pat. Nos. 6,572,784 and 6,841,238 describe pigment flakes in foils which include multiple layers of material in order to provide luminescent and color-shifting properties.

U.S. Pat. No. 4,359,353 shows polypeptides being used to tag a substance through the amino acid sequence found in a particular polypeptide.

U.S. Pat. No. 6,917,749 describes a polymer optical waveguide which has a polymer substrate and a lower cladding on the same. A core on the cladding includes a refractive index which is slightly higher than that of the cladding polymer. In the near infra-red region of light the waveguide function is governed by the optical adsorption by the core in the cladding material.

U.S. Pat. Nos. 4,131,064, 4,053,433, and 620,628 describe tagging articles with micro-particles that are detected by optical means, such as luminescence, x-ray analysis, or color.

U.S. Pat. No. 6,899,827 shows a method of producing translucent ceramic micro-beads which may be used as optical taggants in paints or as dust tracks.

A composition for tracking soil additives would be a notable advance in the field of agriculture forestry, construction, soil erosion prevention, and water management.

### BRIEF SUMMARY OF THE INVENTION

In accordance with the present invention a novel and useful soil additive composition for determining the presence of a spreadable component applied to the surface of the soil is herein provided.

The invention includes a spreadable component which is applied to the soil or the surface of the soil. Such spreading typically takes place by spraying through a pumping mechanism. Spreadable component may be a polymeric material to prevent soil erosion and may also include fertilizers or biocidal materials. In addition, the spreadable component is, at times, augmented with microbes and solid mulching materials such as straw, bark, fiber, cellulose, grasses, synthetic fibers, compost, and the like. Further, chemicals such as tackifiers, binders, glues, adhesives, and bittering agents have been combined with spreadable materials.

A plurality of particles which are reflective of electromagnetic radiation are also included in the present invention. In addition, particles generating or emitting electromagnetic radiation via chemical or radioactive means and the like may also be employed. The plurality of particles are employed as an admixture with the spreadable composition prior to application to the surface of the soil. Following application, the plurality of particles are positioned in the admixture and are easily discerned by an observer using visual senses or instrumentation at a selected distance from the applied admixture in the presence of electromagnetic radiation. That is to say, the plurality of particles reflect or emit light and may appear as a specific color of light. Such color would be determined by the chemical composition of the plurality of particles. Needless to say, the particles may also reflect electromagnetic radiation in the non-visible spectrum, such as the ultra-violet or infra-red regions. The plurality of particles may comprise flattened members that are composed of metallic or non-metallic materials. In addition, certain particles may be multi-layered, especially those formed of polymeric materials. Typically, the particles include a transverse dimension of no larger than 5.0 cm.

The application of the composition of the present invention ratio of the plurality of particles to the spreadable component may vary between 10 to 1 and 100,000 to 1. The lower ratio indicates the use of polymeric materials and the plurality of particles of the present invention, only. The higher ratio represents the use of the plurality of particles combined with the spreadable material having the addition of oil, water, or mulching material.

Most importantly, polymeric materials used as spreadable component decrease in liquidity after being applied to the surface of soils. Such gelling or hardening also holds the plurality of particles at the surface or within the polymeric material. Since the polymeric material is generally translucent, the plurality of particles are visible when held beneath the outer surface of the polymeric material.

It may be apparent that a novel and useful soil additive composition has been herein above described.

It is therefore an object of the present invention to provide a soil additive composition having visual perceptibility which may be used as an indicator of the presence of a spreadable component onto a soil surface.

Another object of the present invention is to provide a soil additive composition having visual perceptibility in which the presence of a spreadable component of the additive composition is indicated after application and at a notable distance from the applied composition.

Another object of the present invention is to provide a soil additive composition having visual perceptibility by the reflection of light or other bands of electromagnetic radiation.

Another object of the present invention is to provide a soil additive composition having visual perceptibility which may be combined with spreadable components, including polymeric material, fertilizers, biocides, and the like for application to soils.

A further object of the present invention is to provide a soil additive composition having visual perceptibility in which particulate matter in the composition reflects light a particular color and at various angles of reflection from the particulate matter.

Another object of the present invention is to provide a soil additive composition having visual perceptibility which may be combined with soil erosion control elements or water management elements, such as polymeric material, natural or synthetic fibrous material, water, and oils.

Another object of the present invention is to provide a soil additive composition having visual perceptibility which includes a spreadable polymeric component which may be employed as a tackifier, binder, or adhesive with soils.

Another object of the present invention is to provide a soil additive composition having visual perceptibility which may be used in hydroseeding operations.

Yet another object of the present invention is to provide a soil additive composition having visual perceptibility which indicates subsequent traffic patterns, including unauthorized entries on the areas to which the composition has been applied.

Another object of the present invention is to provide a soil additive composition having visual perceptibility which indicates a specific characteristic of a spreadable component found as an element of the composition.

Another object of the present invention is to provide a soil additive composition having visual perceptibility which may serve as a bird repellant.

Another object of the present invention is to provide a soil additive composition having visual perceptibility which may be applied in a slurry by spraying or irrigation equipment, via a pump or by gravity flow.

A further object of the present invention is to provide a soil additive composition having visual perceptibility in which a plurality of particles are combined as an admixture with a spreadable component and are held by the spreadable component following application to prevent migration of the plurality of particles.

A further object is to provide a soil additive having visual perceptibility which indicate an area of pollution to authorities in charge of enforcement.

Yet another object of the present invention is to provide a soil additive having perceptibility utilizing visual and instrument detection method in which a plurality of particles is receptive of electromagnetic radiation or is capable of generating a signal.

Yet another object of the present invention is to provide a soil additive having perceptibility in low light or dark conditions.

Another object of the present invention is to provide a soil additive having perceptibility as a prepackaged item.

The invention possess other objects and advantages especially as concerns particular characteristics and features thereof which will become apparent as the specification continues.

### BRIEF DESCRIPTION OF THE SEVERAL VIEWS OF THE DRAWING

FIG. 1 is a schematic side elevational view of a mound of soil after application of the composition of the present invention.

FIG. 2 is a top plan view of a typical particle reflective of electromagnetic radiation employed in the present invention.

FIG. 3 is a broken sectional view taken along line 3-3 of FIG. 2 indicating the multi-layer construction of the exemplar particle of FIG. 2.

FIG. 4 is a sectional view of the spreadable component of the composition of the present invention after application to a soil surface holding reflective particles mechanically or chemically.

For a better understanding of the invention reference is made to the following detailed description of the present invention which should be referencing the prior described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

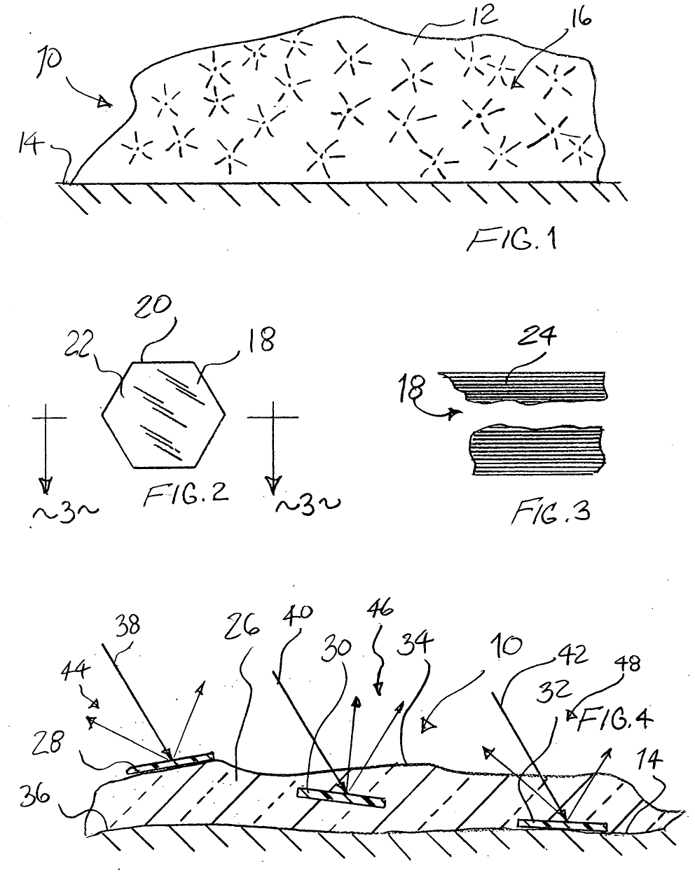

An embodiment of the present invention is shown as a whole by reference character 10, FIGS. 1 and 4. The soil additive composition 10 of the present invention has visual perceptibility qualities which is indicated by the ray lines surrounding the particles on FIG. 1. In FIG. 1, the composition 10 of the present invention has been spread on a mound of soil 12 located above ground surface 14. Composition 10 when spread on soil 12 exhibits a sparkle or coruscation in the presence of sunlight or other sources of light or electromagnetic radiation.

Each of the particles in the plurality of particles 16 of composition 10 may take the form of exemplar particle 18 which produces a discernable signal upon receipt of electromagnetic radiation, FIG. 2. Particle 18 includes a hexagonal perimeter 20 and a reflecting upper surface 22. Particle 18 is formed as a flattened member and is usually no larger than 0.1 cm across. With reference to FIG. 3, it may be observed that particle 18 is composed of multiple layers 18, many of which are translucent. For example, the pigment flakes shown in U.S. Pat. No. 6,572,784 would suffice as a source of particle 18 in this regard. It should be noted that any metallic or non-metallic particle, such as particle 18, that includes reflective surface 22 and, preferably, an opposite reflective surface may be employed in the present invention. Also, a particle may be formed of a material emitting electromagnetic radiation following receipt of electromagnetic radiation i.e.: a particle that luminesces, fluoresces, phosphoresces, and the like. For example particles which are 50% polyethylene terephthalate, 45% ZnS:Cu and 5% epoxy resin coating, sold by Meadowbrook Inventions Inc. of Bernardsville, N.J. would suffice in this regard.

A spreadable component 26 is also employed in the present invention, FIG. 4. Plurality of particles 16 and spreadable component are initially formed as an admixture which may be spread on soil surface 14 by spraying, or other suitable methods known in the art. It should be realized that spreadable component 26 may be combined, not only with plurality of particles 16 but other elements such as water, oil, fertilizer, biocidal solutions, mulch, and the like. As depicted in FIG. 4 spreadable component is depicted as a polymeric material of generally translucent configuration after application. In this regard, spreadable component 26 is capable of holding or fixing particles 28, 30, or 32 as shown. For example, particle 38 is located at the upper surface 34 of applied spreadable component 26. Particle 30 lies below surface 26 but above ground surface 14, while particle 32 lies at lower surface 36 of applied spreadable component 26 at ground surface 14. It should be seen that particles 28, 30, and 32 are held to applied spreadable component 26 by chemical or mechanical mean. Since applied spreadable component 26 is relatively translucent, light incident from a source such as the sun, rays 38, 40, and 42 reflect in multiple directions due to the multiple layers 24 of typical particle 18, FIG. 3. Plurality of rays 44, 46, and 48 associated with particles 28, 30, and 32, respectively indicates such scattering or dispersion of light at the surface 26 of spreadable component 26 or below such surface 26.

Spreadable component 26 may take the form of a polymeric material without the addition of water, oil, or other solid components. For example, such polymeric material may take the form of sodium dicotyl sulfosuccinate, polyvinyl alcohol, polyvinyl acrylic emulsion polymer, trisiloxane/polysiloxane, a 2-propionic acid, polyvinyl acrylic polymer in water, butadiene, polybutadiene, polyacrylamide, polyacralymide-water, linear polyacrylamide, latex, polyvinyl acetate, polydimethylsiloxane, polyurethane, sodium acrylate, acrylamide and like materials, including blends and admixtures of the above.

Further, spreadable component may be formed of naturally occurring polymers and modified polymers derived from biological sources including those obtained from bacterial, fungal, plant and animal sources such as alginates, starches, modified and pregelatinized starches, polysacharrides, glucosamine and polyglucosamine, polypeptides, chitan, complex sugars, gelatin, latex, natural rubber, vegetative oils such as derived from soy oils, pine oil or linseed oil and, Xanthum gums.

Spreadable component 26 may also be combined with fertilizers, pesticides, herbicides, biocides, and like materials. Also, any of the materials used in hydroseeding may be employed with spreadable component 26. As heretofore stated, spreadable component 26 is generally applied to soil 12 in a liquid form, but transforms into a solid or semi-solid material when applied to soil surface 14.

Typically, one pound of plurality of particle 16 is used per acre of land represented by ground surface 14. In certain cases one pound of particles 16 is combined with anywhere between 4 to as much as 6,000 gallons of spreadable component 26 which may include a polymeric component, heretofore described, alone, or combined with water, oil, and other liquid and solid components. Thus, on a weight basis, the ratio of spreadable component 26 to plurality of particle 16 generally ranges between 10 to 1 and up to 100,000 to 1.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A soil additive composition having usual perceptibility, comprising:
a. spreadable component applicable to the soil; and
b. a plurality of particles receptive of electromagnetic radiation, said plurality of particles being an ad mixture with said spreadable composition applied to the surface of the soil and being positioned in said admixture for production of a signal discernable by an observer at a selected distance from said ad mixture in the presence of electromagnetic radiation.

2. The composition of claim 1 in which said electromagnetic radiation comprises visible light.

3. The composition of claim 1 in which said plurality of particles comprises flattened members.

4. The composition of claim 1 in which each of said plurality of particles comprises a non-metallic member having a reflective surface.

5. The composition of claim 1 in which each of said plurality of particles comprises a metallic member having a reflective surface.

6. The composition of claim 1 in which said plurality of particles include a transverse dimension of no longer than 5.0 cm.

7. The composition of claim 6 which the composition of claim 1 in which said plurality of particles comprises flattened members.

8. The composition of claim 1 in which said ratio of spreadable component to said plurality of particles on a weight basis ranges between 10 to 1 and 100,000 to 1.

9. The composition of claim 1 in which said spreadable material comprises a fertilizer.

10. The composition of claim 1 in which said spreadable material comprises a pesticide.

11. The composition of claim 1 in which said plurality of particles emit electromagnetic radiation.

12. The composition of claim 1 in which said spreadable component comprises a polymeric material and said plurality of particle are held by said polymeric material.

13. The composition of claim 12 in which the composition of claim 1 in which said electromagnetic radiation comprises visible light.

14. The composition of claim 12 in which the composition of claim 1 in which said plurality of particles comprises flattened members.

15. The composition of claim 12 in which the composition of claim 1 in which each of said plurality of particles comprises a non-metallic member having a reflective surface.

16. The composition of claim 12 in which the composition of claim 1 in which each of said plurality of particles comprises a metallic member having a reflective surface.

17. The composition of claim 12 in which the composition of claim 1 in which said spreadable material comprises a pesticide.
